(19) United States
(12) Patent Application Publication
(10) Pub. No.: US 2023/0350175 A1
(43) Pub. Date: Nov. 2, 2023

(54) LED-BASED LIGHT-FOCUSING DEVICE USING FREEFORM LENS

(71) Applicant: Inha University Research and Business Foundation, Incheon (KR)

(72) Inventors: Daeyu Kim, Incheon (KR); Dong Jin Lee, Incheon (KR); Kyu Sung Kim, Incheon (KR)

(73) Assignee: Inha University Research and Business Foundation, Incheon (KR)

(21) Appl. No.: 18/338,084

(22) Filed: Jun. 20, 2023

(30) Foreign Application Priority Data
Mar. 15, 2022 (KR) 10-2023-0034160
Oct. 5, 2022 (KR) 10-2022-0127281

(51) Int. Cl. G02B 19/00; G02B 27/00

(52) U.S. Cl. CPC G02B 19/0061; G02B 27/0012; G02B 19/0009

(57) ABSTRACT

A LED-based light focusing method and system using an advanced freeform lens designs are proposed. The LED-based light focusing method and system using a freeform lens proposed in the present disclosure includes the steps of; calculating an initial condition for an intermediate wavefront from input ray vector of an incident light source and prescribed irradiance on target plane; finding a solution for the intermediate wavefront through numerical analysis by using the Monge-Ampère equation; calculating a surface of the freeform lens by applying the Snell's law; updating an outgoing ray sequence from the freeform surface data; and generating an optimized freeform lens surface by repeatedly reconstructing new intermediate wavefront.

### TECHNICAL FIELD

The present disclosure relates to an LED-based light focusing device using a freeform lens and an operation method thereof.

### BACKGROUND ART

Lasers are one of the representative semiconductor-based light sources and have characteristics of monochromaticity, directionality, and coherency through a highly concentrated narrow beam which is amplified using optical cavity-based stimulated radiation. Based on these properties, laser technologies have contributed to development in the fields of medical, military, and scientific research.

A laser light source produces intense power within a small focal area and this high focused light energy makes lasers useful in micro-scale material processing, soft tissue surgery, and cancer treatment. However, laser light sources are expensive, bulky, and costly to maintain because of the need for resonators as well as pumping devices, making them difficult to use in the fields of endoscopes, medical robots, and small-sized diagnosis and treatment devices.

In contrast, light-emitting diodes (LEDs) have significant advantages over the laser including low cost, compact size, and ease of installation. However, there is a limitation to use of the LEDs as high power focused light sources because LEDs produce much larger beam divergence than the laser.

In the circumstances, there is a need for the development of LED-based focused light source modules that do not use an expensive optical resonator but have beam directionality and focusing characteristics as lasers have.

Korean Patent Registration No. 10-1439746 relates to a construction method and system for constructing a 3-dimensional freeform lens for illuminating a rectangular area very efficiently and uniformly, which discloses a technique for constructing a 2-dimensional cross-sectional lens shape with a combination of a refractive surface and a total reflective surface optimized for each of horizontal and vertical directions of a lighting area.

However, the conventional LED-based freeform lenses are designed to have a uniform illuminance in a certain area for use in street lighting, indoor/outdoor lighting, and automobile lamp. Here, the proposed freeform lens design is required in different ways to generate a focused light source. Although design methodologies of freeform lenses for LED light sources have mainly depended on the assumption of an ideal light source, advanced freeform lens design techniques are needed for considering actual LED sizes.

### PRIOR ART DOCUMENT

### Patent Document

Korean Patent Registration No. 10-1439746 (2014.09.02)

### DISCLOSURE OF INVENTION

### Technical Problem

A technical aspect of the present disclosure relates to the design of a freeform lens for creating an LED-based focused light source as well as provides a method and system for generating prescribed target irradiance distribution with the micrometer-scale dimension by positioning a freeform lens in front of the LED. The present disclosure proposes a method and system for an LED-based focused light source with efficient light control and optimized light distribution by introducing a freeform lens in front of the LED. Furthermore, this disclosure proposes a method and system for designing a freeform lens with efficient light control and optimized light distribution for an extended LED light source by overcoming conventional lens design techniques that assume an ideal point light source.

### Solution to Problem

In one aspect, a freeform lens design proposed in the present disclosure for an LED-based light focusing includes the steps of: estimating an initial condition for an intermediate wavefront from an input ray vector of an incident light source and prescribed irradiance on a target plane; finding a solution for the intermediate wavefront through numerical analysis by using the Monge-Ampère equation; calculating a surface of the freeform lens by applying the Snell's law; updating an outgoing ray sequence from the freeform surface data; and repeatedly reconstructing new intermediate wavefront and generating an optimized freeform lens surface.

In another aspect, a freeform lens design proposed in the present disclosure for an LED-based light focusing includes: an initial information generation part that estimates an initial condition for an intermediate wavefront from input ray vector of an incident light source and prescribed irradiance on target plane; a data analysis part that finds a solution for the intermediate wavefront through numerical analysis by using the Monge-Ampère equation, and that calculates a surface of the freeform lens by applying the Snell's law; and a freeform lens reconstruction part that updates an outgoing ray sequence from the freeform surface data, and that generates an optimized freeform lens surface by repeatedly reconstructing new intermediate wavefront.

In yet another aspect, a freeform lens design method for controlling the light distribution of an extended LED source proposed in the present disclosure includes the steps in which: a ray mapping part divides an extended LED source into a predetermined size using stereographic projection and segmentation as well as estimates an initial condition for an intermediate wavefront from input ray vector of an extended LED source with the multiple segments and prescribed irradiance on the target plane; a lens surface calculation part finds a solution for the intermediate wavefront through numerical analysis by using the Monge-Ampère equation and calculates a surface of the freeform lens by applying the Snell's law; a wavefront reconstruction part updates an outgoing ray sequence from the freeform surface and repeatedly reconstructs new intermediate wavefront and generates an optimized freeform lens surface.

In the step in which a ray mapping part divides an extended LED source into light sources of a predetermined size using stereographic projection and segmentation as well as estimates an initial condition for an intermediate wavefront from an input ray vector of the extended LED source with the multiple segments and prescribed irradiance on target plane. The extended LED source is represented using stereographic projection, and each segmented light source is approximated to an ideal point light source.

In the step in which a lens surface calculation part finds a solution for the intermediate wavefront through numerical analysis by using the Monge-Ampère equation and calculates a surface of the freeform lens by applying the Snell's law. The intermediate wavefront is discretized in a uniform grid using a finite difference scheme, and each grid points is applied to the Monge-Ampère equation for finding the solution numerically.

In the step in which a wavefront reconstruction part updates an outgoing ray sequence from the freeform surface and repeatedly reconstructs new intermediate wavefront as well as generates an optimized freeform lens surface. New ray mapping information is generated by using the solution to the Monge-Ampere equation. In addition, an optimized freeform surface is generated by determining whether the new ray mapping information meets the Snell's law.

### Advantageous Effects of Invention

According to embodiments of the present disclosure, it is possible to design a freeform lens for creating an LED-based focused light source, thereby generating prescribed target irradiance distribution with the micrometer-scale dimension. Through the present disclosure, it is possible to manufacture an LED-based focused light source, especially to replace some of the lasers used in fields of micro-scale material processing, soft tissue surgery, and cancer treatment. Furthermore, according to embodiments of the present disclosure, it is possible to overcome the limitations of existing freeform lens design techniques that assume an ideal point light source through a technique for designing a freeform lens with efficient light control and optimized light distribution for an extended LED light source.

### BRIEF DESCRIPTION OF DRAWINGS

The accompanying drawings included as a part of the detailed description of the present disclosure provide embodiments of the present disclosure as well as describe the technical information of the present disclosure along with the detailed description.

FIG. 1 is a flowchart for explaining an LED-based light focusing method using a freeform lens according to an embodiment of the present disclosure.

FIG. 2 is a conceptual diagram showing the design of a freeform lens according to an embodiment of the present disclosure.

FIG. 3 is a view for explaining a process of approximating to a Lambertian light source according to an embodiment of the present disclosure.

FIG. 4 is a view for explaining coordinate systems of an LED-based light source according to an embodiment of the present disclosure.

FIG. 5 is a view for explaining a process of finding a solution to the Monge-Ampère equation through numerical analysis according to an embodiment of the present disclosure.

FIG. 6 is a view for explaining the relationship between the ray vector and wavefront of an output ray according to an embodiment of the present disclosure.

FIG. 7 is a view illustrating a configuration of an LED-based light focusing system using a freeform lens according to an embodiment of the present disclosure.

FIG. 8 is a view showing the shape of a freeform lens according to an embodiment of the present disclosure.

FIG. 9 is a flowchart for explaining a freeform lens design method for controlling the light distribution of an extended LED light source according to an embodiment of the present disclosure.

FIG. 10 is a view for explaining a process of segmenting a disc-shaped extended LED light source according to an embodiment of the present disclosure.

FIG. 11 is a view for explaining a process of representing an LED light source using stereographic projection according to an embodiment of the present disclosure.

FIG. 12 is a view showing the concept of light distribution control of a lens with double freeform surfaces according to an embodiment of the present disclosure.

FIG. 13 is a view showing a configuration of a freeform lens design system for controlling the light distribution of an extended LED light source according to an embodiment of the present disclosure.

FIG. 14 is a graph showing results of generation of a freeform lens surface for a disc-shaped LED light source according to an embodiment of the present disclosure.

FIG. 15 is a view showing a distribution of output light for a freeform lens surface according to an embodiment of the present disclosure.

### MODE FOR THE INVENTION

The present disclosure relates to the design of a freeform lens for converting an LED-based light source with divergent light emission into a prescribed irradiance on the target plane with a micrometer-scale dimension, which includes the steps of: estimating an initial condition for an intermediate wavefront from an input ray vector of an incident light source and prescribed irradiance on the target plane; finding a solution for the intermediate wavefront through numerical analysis by using the Monge-Ampère equation; calculating a surface of the freeform lens by applying the Snell's law; updating an outgoing ray sequence from the freeform surface data; and repeatedly reconstructing new intermediate wavefront and generating an optimized freeform lens surface. Hereinafter, an embodiment of the present disclosure will be described in detail with reference to the accompanying drawings.

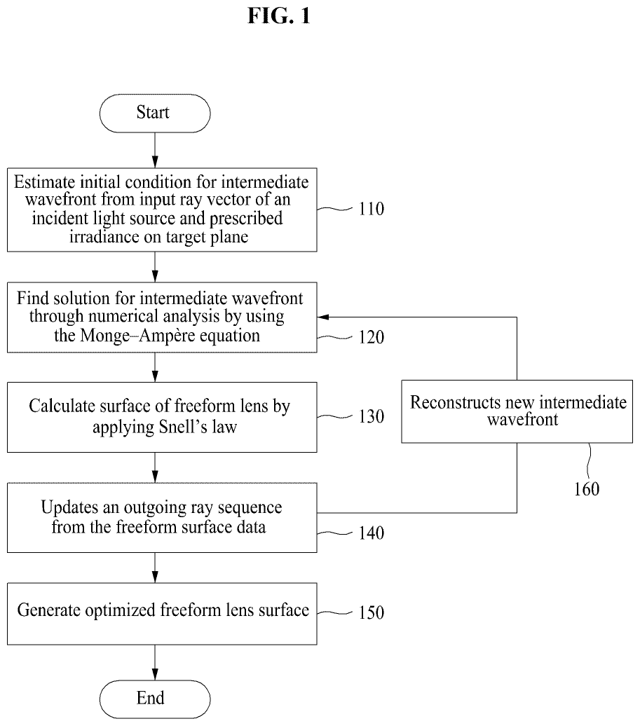

FIG. 1 is a flowchart for explaining an LED-based light focusing method using a freeform lens according to an embodiment of the present disclosure.

The LED-based light focusing method using a freeform lens includes the step 110 of estimating an initial condition for an intermediate wavefront from input ray vector of an incident light source and prescribed irradiance on target plane; the steps 120 and 130 of finding a solution for the intermediate wavefront through numerical analysis by using the Monge-Ampère equation and calculating a surface of the freeform lens by applying the Snell's law; the step 140 of updating an outgoing ray sequence from the freeform surface data; and the step 150 of generating an optimized freeform lens surface by repeatedly reconstructing 160 new intermediate wavefront.

The present disclosure suggests a technique for designing a freeform lens to form an LED-based focusing light source, and therefore overcomes the limitations of existing freeform lens design techniques that assume an ideal point light source through a technique for designing a freeform lens with efficient light control and optimized light distribution for an extended LED light source.

According to an embodiment of the present disclosure, an initial condition for an intermediate wavefront is estimated from input ray vector of an incident light source and prescribed irradiance on target plane (110).

According to an embodiment of the present disclosure, a solution for the intermediate wavefront is found through numerical analysis by using the Monge-Ampère equation (120), and a surface of the freeform lens is calculated by applying the Snell's law (130).

Lastly, ray mapping is updated an outgoing ray sequence from the freeform surface data (140), and an optimized freeform lens surface is generated (150) by repeatedly reconstructing (160) new intermediate wavefront.

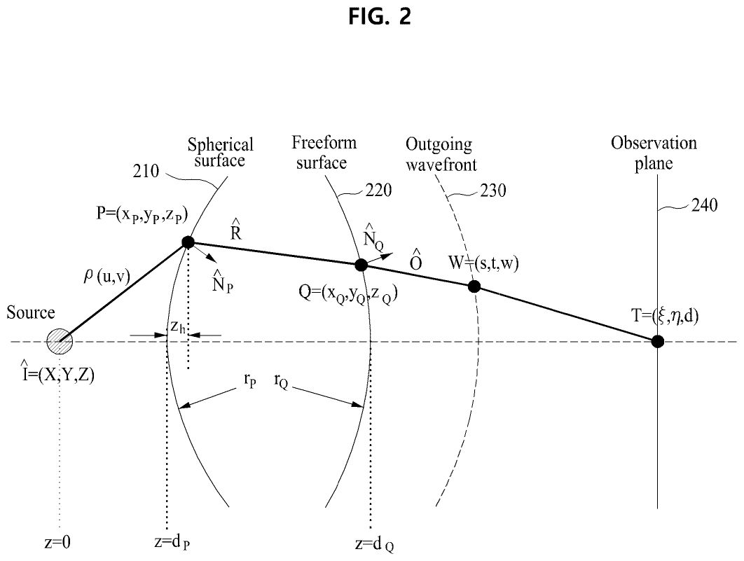

FIG. 2 is a conceptual diagram showing the design of a freeform lens according to an embodiment of the present disclosure. When a unit ray vector of an incident light source is given as Î=(X,Y,Z), light emitted from the light source passes through one point P=(x_{P},y_{P},z_{P}) on Lens Surface 1 (spherical surface), moves past one point Q=(x_{Q},y_{Q},z_{Q}) on Lens Surface 2 (freeform surface), and reaches one point T=(ξ,η,d) on a target plane (observation plane). In this case, the distance from the light source to Lens Surface 1 along the optical axis is denoted by d_{P}, the distance from the light source to Lens Surface 2 along the optical axis is denoted by d_{Q}, the curvature radius of Lens Surface 1 is denoted by r_{P}, a unit normal vector at Point P on Lens Surface 1 is denoted by \hat{N}_{P}, and a unit normal vector at Point Q on Lens Surface 2 is denoted by \hat{N}_{Q}. Also, for the simplicity of the equation and the convenience of calculation, an intermediate wavefront is introduced between Lens Surface 2 and the target plane, and the point at which a ray reaching Point T on the target plane through Point Q on Lens Surface 2 meets the intermediate wavefront is denoted by W=(s,t,w).

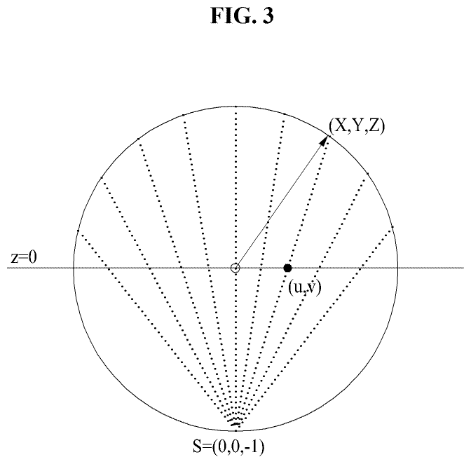

The conceptual diagram showing the design of a freeform lens proposed in the present disclosure is as shown in FIG. 2. Light emitted from an LED light source is refracted at Lens Surface 1 (spherical surface) 210, goes past the inside of a lens with a refractive index of n, and is then refracted again at Lens Surface 2 (freeform surface) 220 and focused on the observation plane 240. In this case, the LED-based light source may be approximated to a Lambertian light source, which will be described with reference to FIG. 3.

FIG. 3 is a view for explaining a process of approximating to a Lambertian light source according to an embodiment of the present disclosure.

FIG. 3 is a view for explaining stereographic projection.

An input ray vector according to the embodiment illustrated in FIG. 3 is as follows:

$$\{ \begin{matrix}\frac{X}{u} = \frac{Y}{v} = Z + 1 , \\ {X}^{2} + {Y}^{2} + {Z}^{2} = 1\end{matrix} \{ \begin{matrix}\begin{matrix}X = \frac{2 u}{1 + {u}^{2} + {v}^{2}} , \\ Y = \frac{2 v}{1 + {u}^{2} + {v}^{2}} ,\end{matrix} \\ Z = \frac{1 - {u}^{2} - {v}^{2}}{1 + {u}^{2} + {v}^{2}}\end{matrix}$$

A solid angle according to the embodiment of the present disclosure may be expressed as follows:

$$d Ω = \vert {\hat{r}}_{u} \times {\hat{r}}_{v} \vert dudv = {( \frac{1}{1 + {u}^{2} + {v}^{2}} )}^{2} dudv$$

A luminous flux per solid angle may be expressed as follows:

$$d ϕ = I ( u , v ) d Ω = I ( u , v ) {( \frac{1}{1 + {n}^{2} + {v}^{2}} )}^{2} dudv$$

Using this, an irradiance distribution using the approximation of an LED-based light source to a Lambertian light source according to an embodiment of the present disclosure can be represented as follows:

$$\begin{matrix}E ( u , v ) = I ( u , v ) {( \frac{1}{1 + {u}^{2} + {v}^{2}} )}^{2} = {I}_{o} cos ( θ ) {( \frac{1}{1 + {u}^{2} + {v}^{2}} )}^{2} \\ = 4 {I}_{o} \frac{1 - {u}^{2} - {v}^{2}}{{( 1 + {u}^{2} + {v}^{2} )}^{2}}\end{matrix}$$

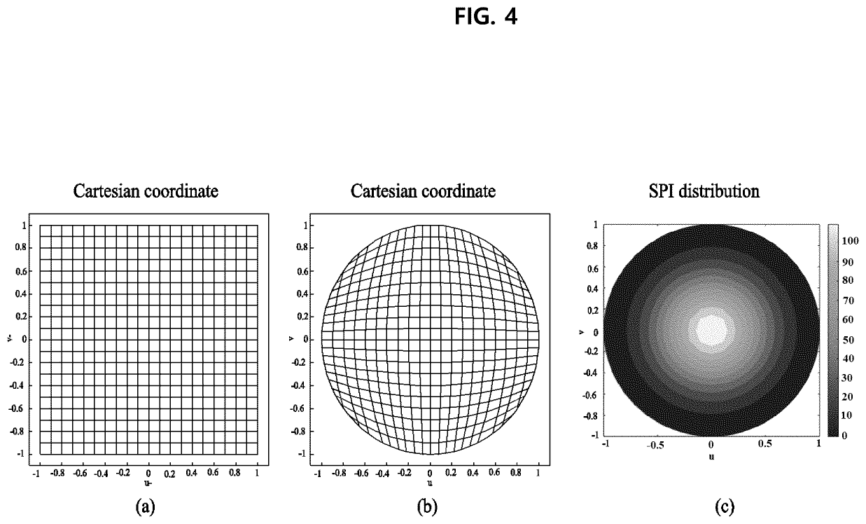

FIG. 4 is a view for explaining coordinate systems of an LED-based light source according to an embodiment of the present disclosure.

(a) of FIG. 4 shows a Cartesian coordinate system, (b) of FIG. 4 shows a circular coordinate system, and (c) of FIG. 4 shows an SPI (stereographically projected irradiance) distribution.

Suppose that the irradiance of the light source is denoted by E(u,v) and the illumination of light reaching the target plane is denoted by L(ξ,q). Then, the law of conservation of energy is established between the illuminations of the light source and the target plane, which can be expressed below by using a Jacobian matrix:

E(u,v)=L(ξ(u,v),η(u,v))|ξᵤηᵥ−ξᵥηᵤ|

wherein a subscript notation in the above equation represents a partial derivative of the function. That is, ξᵤ=∂ξ/∂u, and the same applies to the subsequent equations.

According to the Fermat's principle, the relationship between the intermediate wavefront W=(s,t,w) and the target plane T=(ξ,T,d) can be expressed by the following relational expression:

$${w}_{s} = - \frac{ξ - s}{d - w} ,$$

$${w}_{t} = - \frac{η - t}{d - w}$$

By applying a chain rule to the above equation, the following relational expression can be derived.

wᵤ=wₛsᵤ+wₜtᵤ, wᵥ=wₛsᵥ+wₜtᵥ

Regarding this, the points ξ and η on the target plane can be summarized and expressed as follows:

$$\{ \begin{matrix}ξ = s + ( d - w ) \frac{{t}_{u} {w}_{v} - {t}_{v} {w}_{u}}{γ} \\ η = t + ( d - w ) \frac{{s}_{v} {w}_{u} - {s}_{u} {w}_{v}}{γ}\end{matrix} , herein γ = {s}_{u} {t}_{v} - {s}_{v} {t}_{u}$$

By plugging the above equation into the law of conservation of energy, the point w on the intermediate wavefront is summarized. Then, the following Monge-Ampère equation can be derived:

wᵤᵤwᵥᵥ−wᵤᵥ²+A₁wᵤᵤ+A₂wᵤᵥ+A₃wᵥᵥ+A₄=0

$${A}_{1} = \frac{( {x}_{v} {y}_{vv} - {y}_{v} {x}_{vv} ) {w}_{u} + ( {y}_{v} {x}_{uv} - {x}_{v} {y}_{uv} ) {w}_{v}}{γ} + \frac{{γκ}_{v} {w}_{v} - {X}_{v} {x}_{v} - {Y}_{v} {y}_{v}}{{𝓏}_{2} - w} ,$$

$${A}_{2} = \frac{\begin{matrix}( {y}_{u} {x}_{vv} - {x}_{v} {y}_{uv} + {y}_{v} {x}_{uv} - {x}_{u} {y}_{vv} ) {w}_{u} + \\ ( {x}_{v} {y}_{uu} - {y}_{u} {x}_{uv} + {x}_{u} {y}_{uv} - {y}_{v} {x}_{uu} ) {w}_{v}\end{matrix}}{γ} + \frac{( {X}_{u} {x}_{v} + {Y}_{v} {y}_{u} + {X}_{v} {x}_{u} + {Y}_{u} {y}_{v} ) - γ ( {κ}_{u} {w}_{v} + {κ}_{v} {w}_{u} )}{{𝓏}_{2} - w} ,$$

$${A}_{3} = \frac{( {x}_{u} {y}_{uv} - {y}_{u} {x}_{uv} ) {w}_{u} + ( {y}_{u} {x}_{uu} - {x}_{u} {y}_{uu} ) {w}_{v}}{γ} + \frac{{γκ}_{u} {w}_{u} - {X}_{u} {x}_{u} - {Y}_{u} {y}_{u}}{{𝓏}_{2} - w} ,$$

$${A}_{4} = \frac{\begin{matrix}( {x}_{uv} {y}_{vv} - {x}_{vv} {y}_{uv} ) {w}_{u}^{2} + \\ ( {x}_{vv} {y}_{uu} - {x}_{uu} {y}_{vv} ) {w}_{u} {w}_{v} + ( {x}_{uu} {y}_{uv} - {x}_{uv} {y}_{uu} ) {w}_{v}^{2}\end{matrix}}{γ} + \frac{{κ}_{u}}{{𝓏}_{2} - w} \{ ( {x}_{v} {y}_{vv} - {x}_{vv} {y}_{v} ) {w}_{u}^{2} + ( {x}_{vv} {y}_{u} + {x}_{uv} {y}_{v} - {x}_{v} {y}_{uv} - {x}_{u} {y}_{vv} ) {w}_{u} {w}_{v} + ( {x}_{u} {y}_{uv} - {x}_{uv} {y}_{u} ) {w}_{v}^{2} \} + \frac{{κ}_{v}}{{𝓏}_{2} - w} \{ ( {x}_{uv} {y}_{v} - {x}_{v} {y}_{uv} ) {w}_{u}^{2} + ( {x}_{v} {y}_{uu} + {x}_{u} {y}_{uv} - {x}_{uv} {y}_{u} - {x}_{uu} {y}_{v} ) {w}_{u} {w}_{v} + ( {x}_{uu} {y}_{u} - {x}_{u} {y}_{uu} ) {w}_{v}^{2} \} + \frac{1}{{𝓏}_{2} - w} \{ ( {X}_{u} {x}_{vv} - {Y}_{v} {y}_{uv} - {X}_{v} {x}_{uv} + {Y}_{u} {y}_{vv} ) {w}_{u} + ( {Y}_{v} {y}_{uu} - {X}_{u} {x}_{uv} + {X}_{v} {x}_{uv} - {Y}_{u} {y}_{uv} ) {w}_{v} \} + \frac{1}{κ ( {𝓏}_{2} - w )} \{ ( {X}_{u} {κ}_{v} - {X}_{v} {κ}_{u} ) β + ( {Y}_{v} {κ}_{u} - {Y}_{u} {κ}_{v} ) α + ( {X}_{u} {Y}_{v} - {X}_{v} {Y}_{u} ) - \frac{I}{{I}^{′} ( X + κα , Y + κβ} \}$$

$$X = x + s ; Y = y + t ; κ = \frac{{z}_{2} - w}{γ}$$

$$α = {y}_{u} {w}_{v} - {y}_{v} {w}_{u} ; β = {x}_{v} {w}_{u} - {x}_{u} {w}_{v} ; γ = {x}_{u} {y}_{v} - {x}_{v} {y}_{u}$$

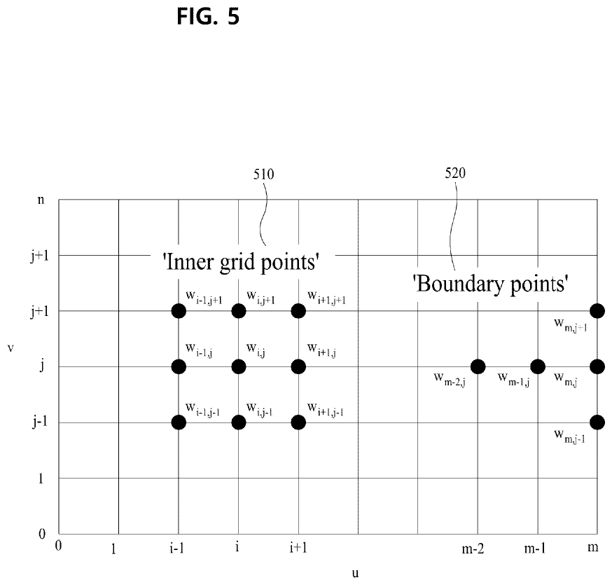

FIG. 5 is a view for explaining a process of finding a solution to the Monge-Ampère equation through numerical analysis according to an embodiment of the present disclosure.

A discretization technique is introduced as shown in FIG. 5 in order to find the solution through numerical analysis by approximating the partial derivative term of the Monge-Ampère equation to a differential term. An approximation of the partial derivative term to the differential term is obtained by using a 9-point finite difference method and can be expressed as follows depending on whether a corresponding point is positioned inside or on a boundary.

Referring to FIG. 5, inner grid points 510 and boundary points 520 are illustrated.

As an example of the 9-point finite difference method according to an embodiment of the present disclosure, a centered difference formula for interior points can be expressed as follows:

$${w}_{u} = \frac{{w}_{i + 1 , j} - {w}_{i - 1 , j}}{2 {h}_{1}} , {w}_{v} = \frac{{w}_{i , j + 1} - {w}_{i , j - 1}}{2 {h}_{2}} ,$$

$${w}_{uu} = \frac{{w}_{i + 1 , j} - 2 {w}_{i , j} + {w}_{i - 1 , j}}{{h}_{1}^{2}} ,$$

$${w}_{vv} = \frac{{w}_{i , j + 1} - 2 {w}_{i , j} + {w}_{i , j - 1}}{{h}_{2}^{2}} ,$$

$${w}_{uv} = \frac{{w}_{i + 1 , j + 1} - {w}_{i + 1 , j - 1} - {w}_{i - 1 , j + 1} + {w}_{i - 1 , j - 1}}{4 {h}_{1} {h}_{2}}$$

A forward (or backward) difference formula for right boundary points can be expressed as follows:

$${w}_{u} = \frac{3 {w}_{i , j} - 4 {w}_{i - 1 , j} + {w}_{i - 2 , j}}{2 {h}_{1}} , {w}_{v} = \frac{{w}_{i , j + 1} - {w}_{i , j - 1}}{2 {h}_{2}} ,$$

$${w}_{uu} = \frac{2 {w}_{i , j} - 5 {w}_{i - 1 , j} + 4 {w}_{i - 2 , j} - {w}_{i - 3 , j}}{{h}_{1}^{2}} ,$$

$${w}_{vv} = \frac{{w}_{i , j + 1} - 2 {w}_{i , j} + {w}_{i , j - 1}}{{h}_{2}^{2}} ,$$

$${w}_{uv} = \frac{\begin{matrix}3 {w}_{i , j + 1} - 3 {w}_{i , j - 1} - 4 {w}_{i - 1 , j + 1} + \\ 4 {w}_{i - 1 , j - 1} + {w}_{i - 2 , j + 1} - {w}_{i - 2 , j - 1}\end{matrix}}{4 {h}_{1} {h}_{2}}$$

A forward (or backward) difference formula for left boundary points can be expressed as follows:

$${w}_{u} = \frac{- 3 {w}_{i , j} + 4 {w}_{i + 1 , j} + {w}_{i + 2 , j}}{2 {h}_{1}} , {w}_{v} = \frac{{w}_{i , j + 1} - {w}_{i , j - 1}}{2 {h}_{2}} ,$$

$${w}_{uu} = \frac{2 {w}_{i , j} - 5 {w}_{i + 1 , j} + 4 {w}_{i + 2 , j} - {w}_{i + 3 , j}}{{h}_{1}^{2}} ,$$

$${w}_{vv} = \frac{{w}_{i , j + 1} - 2 {w}_{i , j} + {w}_{i , j - 1}}{{h}_{2}^{2}} ,$$

$${w}_{uv} = \frac{\begin{matrix}- 3 {w}_{i , j + 1} + 3 {w}_{i , j - 1} + 4 {w}_{i + 1 , j + 1} - \\ 4 {w}_{i + 1 , j - 1} - {w}_{i + 2 , j + 1} + {w}_{i + 2 , j - 1}\end{matrix}}{4 {h}_{1} {h}_{2}}$$

A forward (or backward) difference formula for top boundary points can be expressed as follows:

$${w}_{u} = \frac{{w}_{i + 1 , j} - {w}_{i - 1 , j}}{2 {h}_{1}} , {w}_{v} = \frac{3 {w}_{i , j} - 4 {w}_{i , j - 1}}{2 {h}_{2}} ,$$

$${w}_{uu} = \frac{{w}_{i + 1 , j} - 2 {w}_{i , j} + {w}_{i - 1 , j}}{{h}_{1}^{2}} , {w}_{vv} = \frac{\begin{matrix}2 {w}_{i , j} - 5 {w}_{i , j - 1} + \\ 4 {w}_{i , j - 2} - {w}_{i , j - 2}\end{matrix}}{{h}_{2}^{2}} ,$$

$${w}_{uv} = \frac{\begin{matrix}3 {w}_{i + 1 , j} - 3 {w}_{i - 1 , j} - 4 {w}_{i + 1 , j - 1} + \\ 4 {w}_{i - 1 , j - 1} + {w}_{i + 1 , j - 1} - {w}_{i - 1 , j - 1}\end{matrix}}{4 {h}_{1} {h}_{2}}$$

A forward (or backward) difference formula for bottom boundary points can be expressed as follows:

$${w}_{u} = \frac{{w}_{i + 1 , j} - {w}_{i - 1 , j}}{2 {h}_{1}} , {w}_{v} = \frac{- 3 {w}_{i , j} + 4 {w}_{i , j + 1} - {w}_{i , j + 2}}{2 {h}_{2}} ,$$

$${w}_{uu} = \frac{{w}_{i + 1 , j} - 2 {w}_{i , j} + {w}_{i - 1 , j}}{{h}_{1}^{2}} ,$$

$${w}_{vv} = \frac{2 {w}_{i , j} - 5 {w}_{i , j + 1} + 4 {w}_{i , j + 2} - {w}_{i , j + 2}}{{h}_{2}^{2}} ,$$

$${w}_{uv} = \frac{\begin{matrix}- 3 {w}_{i + 1 , j} + 3 {w}_{i - 1 , j} + 4 {w}_{i + 1 , j + 1} + \\ 4 {w}_{i - 1 , j + 1} + {w}_{i + 1 , j - 2} + {w}_{i - 1 , j + 1}\end{matrix}}{4 {h}_{1} {h}_{2}}$$

The following vector equation for w can be obtained by plugging a differential approximation formula for the partial derivative calculated above into the Monge-Ampère equation:

F(w)=0

In the above equation, w can be obtained by using a Newton-Krylov algorithm. Also, information (ξ(u,v),η(u,v)) on the target plane can be obtained by the above relational expression.

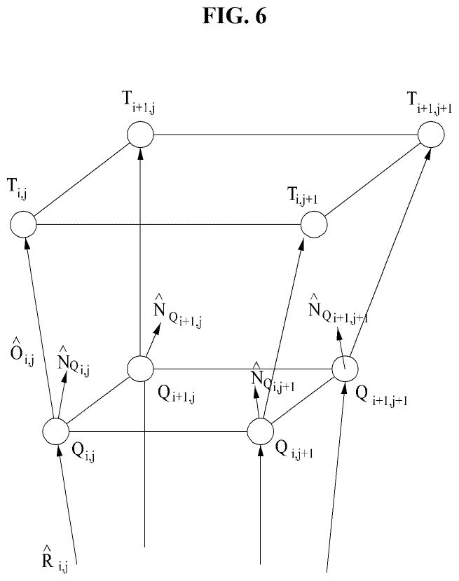

FIG. 6 is a view for explaining the calculation of Lens Surface 2 using information on the intermediate wavefront and target plane obtained above according to an embodiment of the present disclosure.

As shown in FIG. 6, the unit vector of a ray directed toward Lens Surface 2 from Lens Surface 1 can be denoted by \hat{R}_{i,j}, a point on Lens Surface 2 can be denoted by \hat{Q}_{i,j}, a unit normal vector on Lens Surface 2 is denoted by \hat{N}_{Q}_{_{i,j}}, the unit vector of a ray directed toward the target plane from Lens Surface 2 can be denoted by Ô_{i,j}, and a point on the target plane can be denoted by T_{i,j}. In this case, according to the Snell's law, \hat{N}_{Q}_{_{i,j}}, Ô_{i,j}, and \hat{R}_{i,j} can be expressed by the following relational expression:

$${\hat{N}}_{{Q}_{i , j}} = \frac{{\hat{O}}_{i , j} - n {\hat{R}}_{i , j}}{\vert {\hat{O}}_{i , j} - n {\hat{R}}_{i , j} \vert} ,$$

wherein n denotes the refractive index of the lens.

Since the points on the surface of Lens Surface 2 and the unit normal vector of Lens Surface 2 are perpendicular to each other, the following relational expression is established:

(Q_{i+1,j}−Q_{i,j})·(\hat{N}_{Qi+1,j}+\hat{N}_{Qi,j})=0,

(Q_{i,j+1}−Q_{i,j})·(\hat{N}_{Qi,j+1}+\hat{N}_{Qi,j})=0

Moreover, since the points on the intermediate wavefront and the vector Ô_{i,j} directed toward the target plane are perpendicular to each other, the following relational expression is established:

(W_{i+1,j}−W_{i,j})·(Ô_{i+1,j}+Ô_{i,j})=0,

(W_{i,j+1}−W_{i,j})·(Ô_{i,j+1}+Ô_{i,j})=0

The above equation can be obtained by using a least-square algorithm using the Hermann's method, by which the information on Lens Surface 2 and the information on the intermediate wavefront can be updated.

As described above, a freeform lens was designed using the proposed technique, and a simulation test was performed through a ray tracing-based program (LightTools). The light source condition was as follows.

Source type: point source

Angular distribution: Lambertian

Divergence angle: ±60°

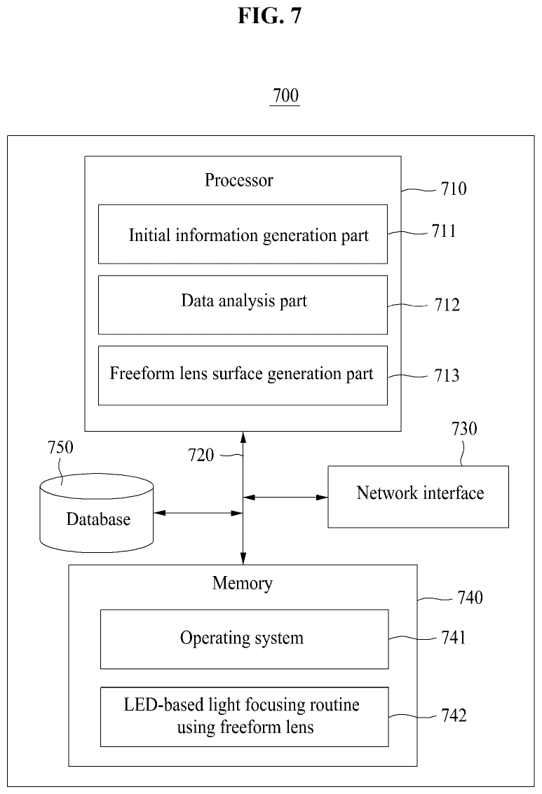

FIG. 7 is a view illustrating a configuration of an LED-based light focusing system using a freeform lens according to an embodiment of the present disclosure.

The LED-based light focusing system 700 according to this embodiment can include a processor 710, a bus 720, a network interface 730, a memory 740, and a database 750. The memory 740 can include an operating system 741 and an LED-based light focusing routine 742 using a freeform lens. The processor 710 can include an initial information generation part 711, a data analysis part 712, and a freeform lens surface generation part 713. n other embodiments, the LED-based light focusing system 700 can include more components than those in FIG. 7. However, there is no need to clearly illustrate most of conventional components. For example, the LED-based light focusing system 700 may include other components such as a display or a transceiver.

The memory 740 is a computer-readable recording medium and can include a permanent mass storage device such as RAM (random access memory), ROM (read only memory), and a disk drive. Also, the memory 740 can store program code for the operating system 741 and for the LED-based light focusing routine 742 using a freeform lens. These software components can be loaded from a computer-readable recording medium, which is separate from the memory 740, by using a drive mechanism (not shown). Such a separate computer-readable recording medium can include a computer-readable recording medium (not shown) such as a floppy drive, a disk, a tape, a DVD/CD-ROM drive, a memory card, etc. In other embodiments, the software components can be loaded onto the memory 740 via a network interface 730 rather than from a computer-readable recording medium.

The bus 720 can enable communication and data transmission between the components of the LED-based light focusing system 700. The bus 720 can be configured using a high-speed serial bus, a parallel bus, a SAN (storage area network), and/or any other suitable communication technology.

The network interface 730 can be a computer hardware component for connecting the LED-based light focusing system 700 to the computer network. The network interface 730 can connect the LED-based light focusing system 700 to the computer network through a wireless or wired connection.

The database 750 can serve to store and maintain all the information required for LED-based light focusing using a freeform lens. Although FIG. 7 illustrates that the database 750 is built and included in the LED-based light focusing system 700, the present disclosure is not limited thereto and can be omitted depending on the system implementation method or environment, or the entire database or a part of it can be present as an external database built on a separate system.

The processor 710 can be configured to process instructions of a computer program by performing basic arithmetical, logical, and I/O operations of the LED-based light focusing system 700. The instructions can be provided by the memory 240 or the network interface 730 and to the processor 710 via the bus 720. The processor 710 can be configured to execute program code for the initial information generation part 711, the data analysis part 712, and the freeform lens surface generation part 713. Such program code can be stored in a recording device such as the memory 740.

The initial information generation part 711, the data analysis part 712, and the freeform lens surface generation part 713 can be configured to perform the steps 110 through 170 of FIG. 1.

The LED-based light focusing system 700 can include the initial information generation part 711, the data analysis part 712, and the freeform lens reconstruction part 713.

In the LED based light focusing method using a freeform lens, the initial information generation part 711 according to the embodiment of the present disclosure calculates an initial condition for an intermediate wavefront from input ray vector of an incident light source and prescribed irradiance on target plane.

The data analysis part 712 according to the embodiment of the present disclosure finds a solution for the intermediate wavefront through numerical analysis by using the Monge-Ampère equation and calculates a surface of the freeform lens by applying the Snell's law.

The freeform lens reconstruction part 713 according to the embodiment of the present disclosure updates an outgoing ray sequence from the freeform surface data, and generates an optimized freeform lens surface by repeatedly reconstructing new intermediate wavefront.

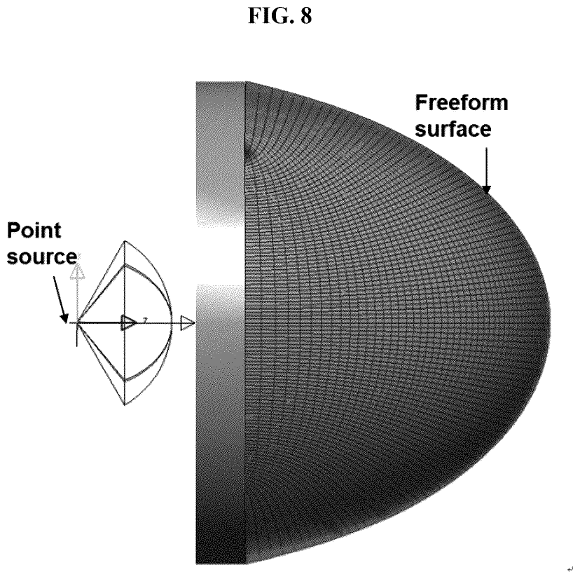

FIG. 8 is a view showing the shape of a freeform lens according to an embodiment of the present disclosure.

With the shape of a freeform lens proposed in the present disclosure, light emitted from an LED light source (point source) can be refracted from Lens Surface 1, pass through the inside of the lens with a refractive index of n, be refracted again against Lens Surface 2 (freeform surface), and focused on the target plane.

A freeform optical system is a technology that is widely used to redistribute an energy distribution of a light source in an intended shape. Most of the current freeform optical systems are designed based on an ideal point light source. However, in general, commonly used LED light sources exist as disc-shaped or rectangular surface light sources, and have various light distributions and emission angles. Accordingly, a freeform optical system designed based on an ideal point light source inevitably has a different distribution than a light distribution intended for an actual environment, and there arise problems such as excessive illumination and energy waste. To solve these problems, the present disclosure proposes a technique for designing a freeform lens to efficiently control the light distribution of an extended LED light source having a disc shape or rectangular shape.

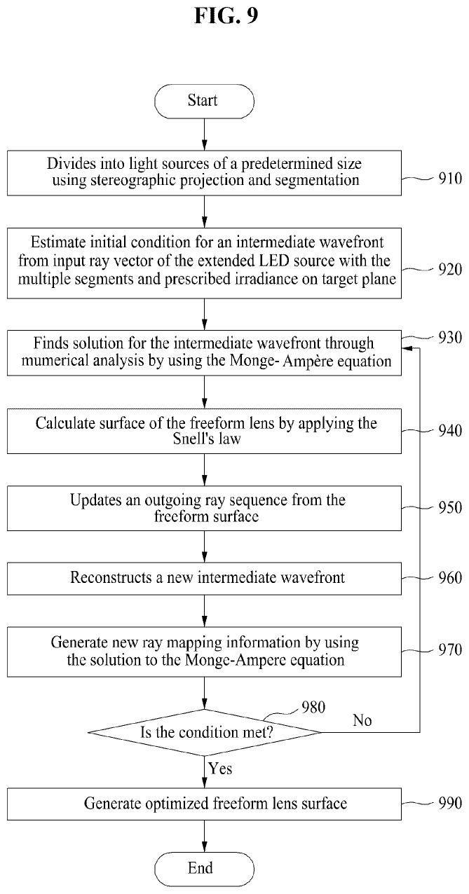

FIG. 9 is a flowchart for explaining a freeform lens design method for controlling the light distribution of an extended LED light source according to an embodiment of the present disclosure.

The proposed freeform lens design method for controlling the light distribution of an extended LED light source includes the steps in which: a ray mapping part divides an extended LED source into a predetermined size using stereographic projection and segmentation and estimates an initial condition for an intermediate wavefront from input ray vector of an extended LED source with the multiple segments and prescribed irradiance on target plane; a lens surface calculation part finds a solution for the intermediate wavefront through numerical analysis by using the Monge-Ampère equation and calculates a surface of the freeform lens by applying the Snell's law; a wavefront reconstruction part updates an outgoing ray sequence from the freeform surface and repeatedly reconstructs new intermediate wavefront and generates an optimized freeform lens surface.

More specifically, in the proposed freeform lens design method, an extended LED light source is divided into light sources of a predetermined size using stereographic projection and segmentation in the step 910. Afterwards, in the step 920, initial condition for an intermediate wavefront is estimated from input ray vector of the extended LED source with the multiple segments and prescribed irradiance on target plane. The extended LED source is represented using stereographic projection, and each segmented light source is approximated to an ideal point light source.

In the step 930, a solution for the intermediate wavefront is found through numerical analysis by using the Monge-Ampère equation. The intermediate wavefront is discretized in a uniform grid using a finite difference scheme, and each grid points is applied the Monge-Ampère equation to find the solution numerically. In the step 940, a surface of the freeform lens is calculated by applying the Snell's law.

In the step 950, an outgoing ray sequence is updated from the freeform surface. In step 960, a new intermediate wavefront is repeatedly reconstructed. In the step 970, a new ray mapping information is generated by using the solution to the Monge-Ampere equation. In the step 980, it is determined whether the new ray mapping information meets the Snell's law. In the step 990, an optimized freeform surface is generated.

In the step 980, if the new ray mapping information does not meet the Snell's law, the flow moves to the step 930, and the steps are repeatedly performed, starting from the step of generating information on output light from the initial ray mapping and a phase distribution.

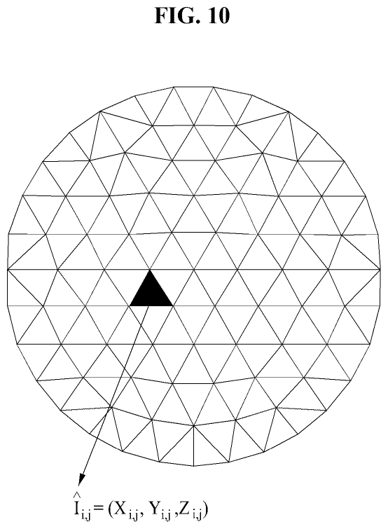

FIG. 10 is a view for explaining a process of segmenting a disc-shaped extended LED light source according to an embodiment of the present disclosure.

In the proposed freeform lens design method for controlling the light distribution of a surface light source, an extended LED light source is divided into light sources of a predetermined size by using light source segmentation as shown in FIG. 10.

Each segmented light source is approximated to a ideal point light source, and the light source is represented using stereographic projection. Initial ray mapping is calculated by obtaining information on the ray vector and wavefront of an incident light source approximated to the point light source.

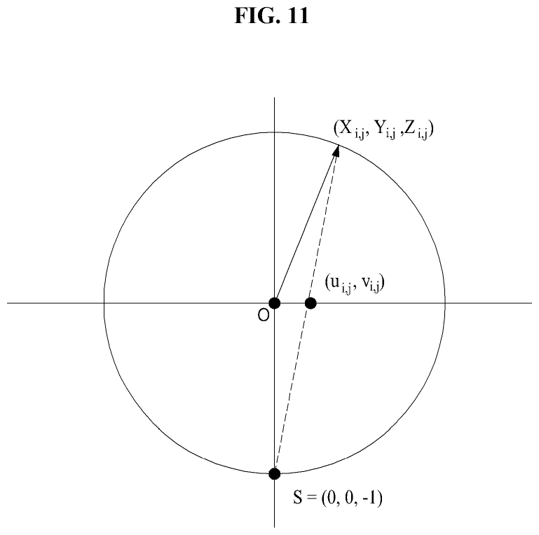

FIG. 11 is a view for explaining a process of representing an LED light source using stereographic projection according to an embodiment of the present disclosure.

Each segmented light source is approximated to a point light source, and the light source is represented using stereographic projection as shown in FIG. 11. Ray vector information of an incident light source approximated to a point light source is as follows:

$${\hat{I}}_{i , j} = \frac{( 2 {u}_{i , j} , 2 {v}_{i , j} , 1 - {u}_{i , j}^{2} - {v}_{i , j}^{2} )}{1 + {u}_{i , j}^{2} + {v}_{i , j}^{2}}$$

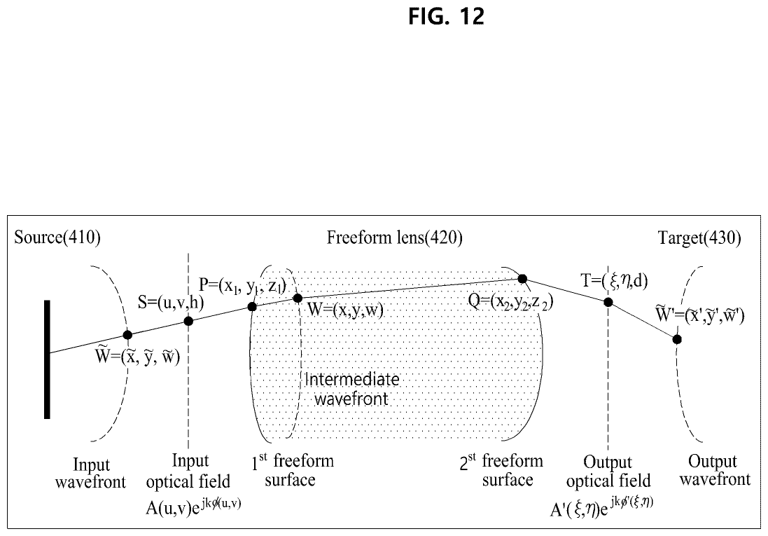

FIG. 12 is a view showing the concept of light distribution control of a lens with double freeform surfaces according to an embodiment of the present disclosure.

The lens with double freeform surfaces is illustrated as having an extended LED light source 1210, a freeform lens 1220, and a target plane 1230 in order to explain a process of controlling the light distribution of an extended LED light source according to an embodiment of the present disclosure.

In the controlling of the light distribution of an extended LED light source according to an embodiment of the present disclosure, a ray emitted from the extended LED light source 1210 goes past the freeform lens 1220 and reaches the target plane 1230.

$${w}_{uu} {w}_{vv} - {w}_{uv}^{2} + {A}_{1} {w}_{uu} + {A}_{2} {w}_{uv} + {A}_{3} + {A}_{4} = 0$$

$${A}_{1} = \frac{( {x}_{v} {y}_{vv} - {y}_{v} {x}_{vv} ) {w}_{u} + ( {y}_{v} {x}_{uv} - {x}_{v} {y}_{uv} ) {w}_{v}}{γ} + \frac{{γκ}_{v} {w}_{v} - {X}_{v} {x}_{v} - {Y}_{v} {y}_{v}}{{𝓏}_{2} - w}$$

$${A}_{2} = \frac{\begin{matrix}( {y}_{u} {x}_{vv} - {x}_{v} {y}_{uv} + {y}_{v} {x}_{uv} - {x}_{u} {y}_{vv} ) {w}_{u} + \\ ( {x}_{v} {y}_{uu} - {y}_{u} {x}_{uv} + {x}_{u} {y}_{uv} - {y}_{v} {x}_{uu} ) {w}_{v}\end{matrix}}{γ} + \frac{( {X}_{u} {x}_{v} + {Y}_{v} {y}_{u} + {X}_{v} {x}_{u} + {Y}_{u} {y}_{v} ) - γ ( {κ}_{u} {w}_{v} + {κ}_{v} {w}_{u} )}{{𝓏}_{2} - w} ,$$

$${A}_{3} = \frac{( {x}_{u} {y}_{uv} - {y}_{u} {x}_{uv} ) {w}_{u} + ( {y}_{u} {x}_{uu} - {x}_{u} {y}_{uu} ) {w}_{v}}{γ} + \frac{{γκ}_{u} {w}_{u} - {X}_{u} {x}_{u} - {Y}_{u} {y}_{u}}{{𝓏}_{2} - w} ,$$

$${A}_{4} = \frac{\begin{matrix}( {x}_{uv} {y}_{vv} - {x}_{vv} {y}_{uv} ) {w}_{u}^{2} + \\ ( {x}_{vv} {y}_{uu} - {x}_{uu} {y}_{vv} ) {w}_{u} {w}_{v} + ( {x}_{uu} {y}_{uv} - {x}_{uv} {y}_{uu} ) {w}_{v}^{2}\end{matrix}}{γ} + \frac{{κ}_{u}}{{𝓏}_{2} - w} \{ ( {x}_{v} {y}_{vv} - {x}_{vv} {y}_{v} ) {w}_{u}^{2} + ( {x}_{vv} {y}_{u} + {x}_{uv} {y}_{v} - {x}_{v} {y}_{uv} - {x}_{u} {y}_{vv} ) {w}_{u} {w}_{v} + ( {x}_{u} {y}_{uv} - {x}_{uv} {y}_{u} ) {w}_{v}^{2} \} + \frac{{κ}_{v}}{{𝓏}_{2} - w} \{ ( {x}_{uv} {y}_{v} - {x}_{v} {y}_{uv} ) {w}_{u}^{2} + ( {x}_{v} {y}_{uu} + {x}_{u} {y}_{uv} - {x}_{uv} {y}_{u} - {x}_{uu} {y}_{v} ) {w}_{u} {w}_{v} + ( {x}_{uu} {y}_{u} - {x}_{u} {y}_{uu} ) {w}_{v}^{2} \} + \frac{1}{{𝓏}_{2} - w} \{ ( {X}_{u} {x}_{vv} - {Y}_{v} {y}_{uv} - {X}_{v} {x}_{uv} + {Y}_{u} {y}_{vv} ) {w}_{u} + ( {Y}_{v} {y}_{uu} - {X}_{u} {x}_{uv} + {X}_{v} {x}_{uv} - {Y}_{u} {y}_{uv} ) {w}_{v} \} + \frac{1}{κ ( {𝓏}_{2} - w )} \{ ( {X}_{u} {κ}_{v} - {X}_{v} {κ}_{u} ) β + ( {Y}_{v} {κ}_{u} - {Y}_{u} {κ}_{v} ) α + ( {X}_{u} {Y}_{v} - {X}_{v} {Y}_{u} ) - \frac{I}{{I}^{′} ( X + κα , Y + κβ} \}$$

$$X = x + s ; Y = y + t ; κ = \frac{{z}_{2} - w}{γ}$$

$$α = {y}_{u} {w}_{v} - {y}_{v} {w}_{u} ; β = {x}_{v} {w}_{u} - {x}_{u} {w}_{v} ; γ = {x}_{u} {y}_{v} - {x}_{v} {y}_{u}$$

The relationship between the ray vector and wavefront of an output ray according to an embodiment of the present disclosure is as follows.

(\tilde{W}_{i+1,j}−\tilde{W}_{i,j})·(O_{i+1,j}+O_{i,j})=0,

(\tilde{W}_{i,j+1}−\tilde{W}_{i,j})·(O_{i,j+1}+O_{i,j})=0

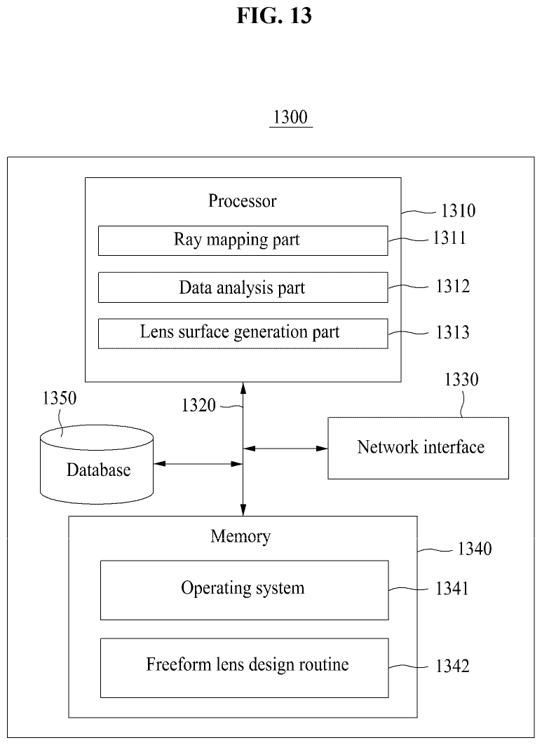

FIG. 13 is a view showing a configuration of a freeform lens design system for controlling the light distribution of a surface light source according to an embodiment of the present disclosure.

The freeform lens design system 1300 according to this embodiment can include a processor 1310, a bus 1320, a network interface 1330, a memory 1340, and a database 1350. The memory 1340 can include an operating system 1341 and a freeform lens design routine 1342. The processor 1310 can include a reliability index evaluation part 1311 and an analysis part 1312. In other embodiments, the freeform lens design system 1300 can include more components than those in FIG. 13. However, there is no need to clearly illustrate a majority of conventional components. For example, the freeform lens design system 1300 can include other components such as a display or a transceiver.

The memory 1340 is a computer-readable recording medium and can include a permanent mass storage device such as RAM (random access memory), ROM (read only memory), and a disk drive. Also, the memory 1340 can store program code for the operating system 1341 and for the freeform lens design routine 1342. These software components can be loaded from a computer-readable recording medium, which is separate from the memory 1340, by using a drive mechanism (not shown). Such a separate computer-readable recording medium can include a computer-readable recording medium (not shown) such as a floppy drive, a disk, a tape, a DVD/CD-ROM drive, a memory card, etc. In other embodiments, the software components can be loaded onto the memory 1340 via a network interface 1330 rather than from a computer-readable recording medium.

The bus 1320 can enable communication and data transmission between the components of the freeform lens design system 1300. The bus 1320 can be configured using a high-speed serial bus, a parallel bus, a SAN (storage area network), and/or any other suitable communication technology.

The network interface 1330 can be a computer hardware component for connecting the freeform lens design system 1300 to the computer network. The network interface 1330 can connect the freeform lens design system 700 to the computer network through a wireless or wired connection.

The database 1350 can serve to store and maintain all the information required for freeform lens design for controlling the light distribution of a surface light source. Although FIG. 13 illustrates that the database 1350 is built and included in the freeform lens design system 1300, the present disclosure is not limited thereto and can be omitted depending on the system implementation method or environment, or the entire database or a part of it can be present as an external database built on a separate system.

The processor 1310 can be configured to process instructions of a computer program by performing basic arithmetical, logical, and I/O operations of the freeform lens design system 1300. The instructions can be provided by the memory 1340 or the network interface 1330 and to the processor 1310 via the bus 1320. The processor 1310 can be configured to execute program code for the reliability index evaluation part 1311 and the analysis part 1312. Such program code may be stored in a recording device such as the memory 1340.

The ray mapping part 1311 may be configured to perform the steps 910 through 990 of FIG. 9.

The freeform lens design system 1300 may include the ray mapping part 1311, the lens surface calculation part 1312, and the wavefront reconstruction part 1313.

The ray mapping part 1311 divides an extended LED source into light sources of a predetermined size using stereographic projection and segmentation and calculates an initial condition for an intermediate wavefront from input ray vector of the extended LED source with the multiple segments and prescribed irradiance on target plane. The extended LED source is represented using stereographic projection, and each segmented light source is approximated to an ideal point light source.

The lens surface calculation part 1312 finds a solution for the intermediate wavefront through numerical analysis by using the Monge-Ampère equation and calculates a surface of the freeform lens by applying the Snell's law. The intermediate wavefront is discretized in a uniform grid using a finite difference scheme, and each grid points is applied the Monge-Ampère equation to find the solution numerically.

The wavefront reconstruction part 1313 updates an outgoing ray sequence from the freeform surface and repeatedly reconstructs new intermediate wavefront and generates an optimized freeform lens surface. New ray mapping information is generated by using the solution to the Monge-Ampere equation. In addition, an optimized freeform surface is generated by determining whether the new ray mapping information meets the Snell's law.

If the new ray mapping information does not meet the Snell's law, the wavefront reconstruction part 1313 generates an optimized freeform lens surface by repeatedly performing the steps, starting from the step of generating information on output light from the initial ray mapping.

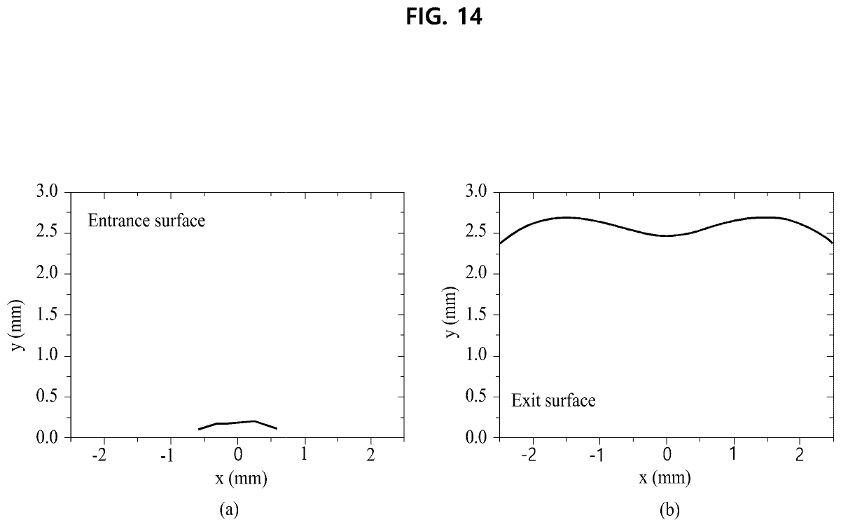

FIG. 14 is a graph showing results of generation of a freeform lens surface for a disc-shaped LED light source according to an embodiment of the present disclosure.

This graph shows results of generation of a freeform lens surface for a disc-shaped LED light source by the method proposed above according to an embodiment of the present disclosure.

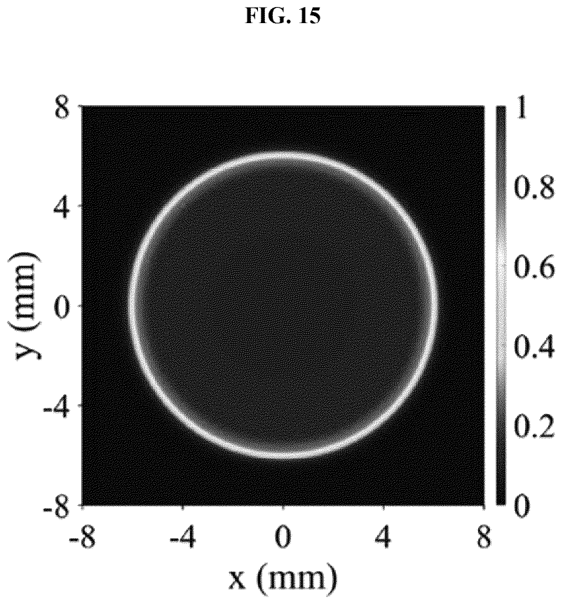

FIG. 15 is a view showing a distribution of output light for a freeform lens surface according to an embodiment of the present disclosure.

The present disclosure suggests a technique for designing a freeform lens to form an LED-based focused light source, and therefore overcomes the limitations of existing freeform lens design techniques that assume an ideal point light source and allows for designing a freeform lens that has optimized energy efficiency in an actual environment.

The above-described system may be implemented in the form of a hardware component or a combination of a hardware component and a software component. For example, the system and components described in the embodiments may be implemented using one or more general-purpose computers or special-purpose computers, such as a processor, a controller, an arithmetic logic unit (ALU), a digital signal processor, a microcomputer, a field programmable gate array (FPA), a programmable logic unit (PLU), a microprocessor, or any other device capable of executing or responding to an instruction. A processing device may run an operating system (OS) and one or more software applications executed on the OS. Furthermore, the processing device may access, store, manipulate, process, and generate data in response to the execution of software. For convenience of understanding, one processing device has been illustrated as being used, but a person having ordinary skill in the art may understand that the processing device may include a plurality of processing elements and/or a plurality of types of processing elements. For example, the processing device may include a plurality of processors or a single processor and a single controller. Furthermore, a different processing configuration, such as a parallel processor, is also possible.

Software may include a computer program, code, an instruction, or a combination of one or more of these and may configure a processing device so that it operates as desired or may instruct the processing device independently or collectively. The software and/or data may be embodied in a machine, component, physical device, virtual equipment, computer storage medium or device of any type in order to be interpreted by the processing device or to provide an instruction or data to the processing device. The software may be distributed to computer systems connected over a network and may be stored or executed in a distributed manner. The software and data may be stored in one or more computer-readable recording media.

The method according to the embodiment may be implemented in the form of a program instruction executable by various computer means and stored in a computer-readable recording medium. The computer readable medium may include a program instruction, a data file, a data structure, or a combination thereof. The program instructions recorded on the medium may be specifically designed for the embodiments or may be well known to one of ordinary skill in the art of computer software. Examples of the computer-readable recording medium include magnetic media such as a hard disk, a floppy disk and a magnetic tape, optical media such as CD-ROM and DVD, magneto-optical media such as a floptical disk, and hardware devices such as ROM, RAM, and flash memory, which are specially configured to store and execute program instructions. Examples of the program of instructions may include not only machine language codes produced by a compiler but also high-level language codes that can be executed by a computer using an interpreter, etc.

As described above, although the embodiments have been described in connection with the limited embodiments and the drawings, those skilled in the art may modify and change the embodiments in various ways from the description. For example, the relevant results may be achieved even when the described technologies are performed in a different order than the described methods, and/or even when the described components such as systems, structures, devices, and circuits are coupled or combined in a different form than the described methods or are replaced or substituted by other components or equivalents.

Therefore, other implementations, other embodiments, and equivalents to the claims are also within the scope of the following claims.

1. A light focusing method, which is provided to design a freeform lens for creating an LED-based focused light source to generate prescribed target irradiance distribution with the micrometer-scale dimension, the method comprising:
calculating an initial condition for an intermediate wavefront from input ray vector of an incident light source and prescribed irradiance on target plane;
finding a solution for the intermediate wavefront through numerical analysis by using the Monge-Ampère equation and calculating a surface of the freeform lens by applying the Snell's law; and
updating an outgoing ray sequence from the freeform surface data; and
generating an optimized freeform lens surface by repeatedly reconstructing new intermediate wavefront.

2. The light focusing method of claim 1, wherein, in the step of calculating an initial condition for an intermediate wavefront from input ray vector of an incident light source and prescribed irradiance on target plane, an initial condition for an intermediate wavefront is calculated from input ray vector of an incident light source and prescribed irradiance on target plane.

3. The light focusing method of claim 1, wherein, in the step of finding a solution for the intermediate wavefront through numerical analysis by using the Monge-Ampère equation and calculating a surface of the freeform lens by applying the Snell's law, a solution for the intermediate wavefront is found through numerical analysis by using the Monge-Ampère equation and a surface of the freeform lens is calculated by applying the Snell's law.

4. The light focusing method of claim 1, wherein, in the step of updating an outgoing ray sequence from the freeform surface data and generating an optimized freeform lens surface by repeatedly reconstructing new intermediate wavefront, an outgoing ray sequence is updated from the freeform surface data as well as an optimized freeform lens surface is generated by repeatedly reconstructing new intermediate wavefront.

5. A light focusing system, the system comprising:
an initial information generation part that calculates an initial condition for an intermediate wavefront from input ray vector of an incident light source and prescribed irradiance on target plane;
a data analysis part that finds a solution for the intermediate wavefront through numerical analysis by using the Monge-Ampère equation, and that calculates a surface of the freeform lens by applying the Snell's law; and
a freeform lens reconstruction part that updates an outgoing ray sequence from the freeform surface data, and that generates an optimized freeform lens surface by repeatedly reconstructing new intermediate wavefront.

6. The light focusing system of claim 5, wherein the initial information generation part calculates an initial condition for an intermediate wavefront from the input ray vector of an incident light source and the prescribed irradiance on the target plane

7. The light focusing system of claim 5, wherein the data analysis part finds a solution for the intermediate wavefront through numerical analysis by using the Monge-Ampère equation and calculates a surface of the freeform lens by applying the Snell's law.

8. The light focusing system of claim 5, wherein the freeform lens reconstruction part updates an outgoing ray sequence from the freeform surface data and generates an optimized freeform lens surface by repeatedly reconstructing new intermediate wavefront.
